(19) United States
(12) Patent Application Publication
(10) Pub. No.: US 2017/0032851 A1
(43) Pub. Date: Feb. 2, 2017

(54) Efficient Compact Fusion Reactor

(71) Applicant: Tokamak Energy Ltd, Abingdon, Oxfordshire (GB)

(72) Inventors: Alan Sykes, Wantage (GB); Mikhail Gryaznevich, Abingdon (GB); David Kingham, Oxford, Oxfordshire (GB)

(73) Assignee: Tokamak Energy Ltd., Abingdon, Oxfordshire (GB)

(21) Appl. No.: 15/303,146

(22) PCT Filed: Apr. 9, 2015
(86) PCT No.: PCT/GB2015/051078

§ 371 Date: Oct. 10, 2016

(30) Foreign Application Priority Data
Apr. 10, 2014 (GB) 1406476.0

(51) Int. Cl. G21B 1/05; H05H 1/12

(52) U.S. Cl. CPC G21B 1/057; H05H 1/12; G21Y 2004/305

(57) ABSTRACT

An efficient compact nuclear fusion reactor for use as a neutron source or energy source includes a toroidal plasma chamber and a plasma confinement system arranged to generate a magnetic field for confining a plasma in the chamber, where the plasma confinement system is configured so that a major radius of the confined plasma is 1.5 m or less and the toroidal magnetic field is operated 5 T or less and the plasma current is 5 MA or less, yet a-particles generated are confined in the plasma.

### TECHNICAL FIELD

The present application relates to a compact fusion reactor operated at high toroidal field. In particular, though not exclusively, the invention relates to a spherical tokamak reactor suitable for use as an energy source or as a highly efficient neutron source

### BACKGROUND

The challenge of producing fusion power is hugely complex. Many alternative devices apart from tokamaks have been proposed, though none have yet produced any results comparable with the best tokamaks currently operating such as JET.

World fusion research has entered a new phase after the beginning of the construction of ITER, the largest and most expensive (c15bn Euros) tokamak ever built. The successful route to a commercial fusion reactor demands long pulse, stable operation combined with the high efficiency required to make electricity production economic. These three conditions are especially difficult to achieve simultaneously, and the planned programme will require many years of experimental research on ITER and other fusion facilities, as well as theoretical and technological research. It is widely anticipated that a commercial fusion reactor developed through this route will not be built before 2050.

To obtain the fusion reactions required for economic power generation (i.e. much more power out than power in), the conventional tokamak has to be huge (as exemplified by ITER) so that the energy confinement time (which is roughly proportional to plasma volume) can be large enough so that the plasma can be hot enough for thermal fusion to occur.

### SUMMARY

In accordance with a first aspect of the present invention there is provided a compact nuclear fusion reactor for use as an energy source or a highly efficient neutron source. The reactor comprises a toroidal plasma chamber in which is confined a plasma comprising tritium ions, and a plasma confinement system arranged to generate a magnetic field for confining the plasma in the plasma chamber. The plasma confinement system is configured so that a major radius of the confined plasma is 1.5 m or less, preferably 1.2 m or less, preferably 1.0 m or less, more preferably 0.8 m or less, more preferably 0.6 m or less. The magnetic field in use includes a toroidal component of 5 T or less, preferably 4 T or less, preferably 3 T or less, more preferably 2 T or less. The plasma current is 5 MA or less, preferably 4 MA or less, preferably 3 MA or less, more preferably 2 MA or less, more preferably 1 MA or less. The aspect ratio is 2.5 or less, preferably less than 2.2, more preferably less than 2.0, more preferably less than 1.8, more preferably less than 1.7. The reactor may thus be a spherical tokamak. A fraction of a-particles generated which are confined within the plasma is 0.4 or greater, preferably 0.5 or greater, more preferably 0.6 or greater, more preferably 0.7 or greater, more preferably 0.8, more preferably 0.9 or greater. Indeed in one embodiment substantially all of the generated a-particles may be confined in the plasma.

Thus a high proportion of a-particles may be confined in a moderately high field spherical tokamak even at plasma currents as low as approximately 2 MA. It will be appreciated that such a-particles are useful to heat the plasma and maintain fusion conditions in a high gain device.

The ratio of tritium ions to deuterium ions in the plasma may be at least about 25:75, preferably at least about 40:60, more preferably at least about 50:50.

The plasma confinement system may include high toroidal field magnets made from material comprising high temperature superconductor, preferably cooled in use to approximately 80K (the boiling temperature of nitrogen is 77K), more preferably to 30K or less, more preferably to 4K or less.

The reactor may be configured so that power input to the plasma is less than 100 MW, preferably less than 10 MW, more preferably less than 6 MW, more preferably less than 3 MW, more preferably less than 1 MW, more preferably less than 500 kW. In other words, in preferred embodiments the reactor is a low energy reactor. However, the reactor is preferably arranged to operate at a fusion energy gain factor Q_{eng}>1, more preferably Q_{eng}>3, more preferably Q_{eng}>10, more preferably Q_{eng}>15, more preferably Q_{eng}>20, and operated either as an efficient neutron source or an energy source.

Previous designs for small fusion devices usually have a problem with wall loading —i.e. the neutron flux or dispersion of plasma heat through the walls of the plasma chamber. The optional use of a low power input to the plasma of 10 MW or less, preferably 6 MW or less, more preferably 3 MW, more preferably 1 MW or less, enables the device to be viable with existing materials and technology.

Neutron production may be enhanced by directing one or more neutral beams into the plasma. The neutral beam or beams may have an energy of less than 200 keV, preferably less than 130 keV, more preferably less than 80 keV, more preferably less than 40 keV. Multiple neutral beams may be directed into the plasma from directions selected to optimise fusion reactions between particles in the beams and the thermal plasma, and may include colliding beams.

In one embodiment, the plasma is maintainable in a steady state for more than 10 seconds, preferably more than 100 seconds, more preferably more than 1000 seconds, more preferably more than 10000 seconds. Indeed, the plasma may be maintainable in a steady state continuously up to a few years. In particular, the plasma energy confinement time may be at least 10% greater than conventionally predicted, preferably 50% greater, more preferably 100% greater, more preferably 2 times greater, more preferably 5 times greater, more preferably 10 times greater. This dramatically increases the usefulness of the neutron or energy production, since the total number of neutrons and amount of energy emitted increases with long pulses. In order to achieve such long pulses, the plasma current may be driven without induction for example by using neutral beams or RF current drive. RF current drive includes any electromagnetic wave technique to drive the current including Electron Bernstein Wave, Lower Hybrid, Ion Cyclotron Resonance and Electron Cyclotron Resonance and any combination thereof. Lower energy neutral beams can be more efficient (per unit energy input) at transferring momentum to drive the current. Furthermore, the ratio of plasma pressure to magnetic pressure may be greater than 5%, preferably greater than 10%, more preferably greater than 20%, more preferably greater than 30%.

The use of HTS magnets helps to maintain the plasma in a steady state because, being a superconductor, there is no heating effect from resistance in the magnet and the current supplies for HTS magnets are more stable than power supplies for resistive magnets.

The plasma may be initiated using merging-compression, or magnetic pumping whereby an oscillating current produces plasma rings to augment the plasma current, or activation of one or more solenoids (which may be retractable) located in a central core of the toroidal chamber, and/or RF current initiation by a gyrotron or other suitable high frequency generator. The plasma current may be ramped up using activation of the solenoids, RF current drive, and/or heating the plasma so that a rapid increase in poloidal field necessary to contain the plasma as it grows inputs almost sufficient flux to ramp-up the plasma current to a desired working value. If retractable solenoids are used they may optionally be pre-cooled high temperature superconducting solenoids. The plasma current may be maintained using RF current drive and/or Neutral Beam injection.

Shielding may be provided around the central column in order to reduce or eliminate damage from neutrons. The HTS manufactured material may be configured to provide enhanced resistance to neutron damage, for example by increasing the thickness of the HTS layer within the HTS manufactured material.

The HTS manufactured material may be configured to provide an increased current density, for example by reducing the thickness of the non-HTS layers or increasing the thickness of the HTS layers within the HTS manufactured material, in order to allow more space for shielding.

The central column may comprise beryllium, aluminium or another non-HTS material that will maintain acceptable levels of structural integrity and conductivity despite the neutron flux. The beryllium, aluminium or other non-HTS material is optionally cryogenically cooled to reduce its resistance and is optionally joined to HTS material forming the remainder of the toroidal magnet apart from the central column.

The inner part of the central column may be made of HTS and the outer part made of beryllium, aluminium or another non-HTS material that provides shielding against damage to the HTS from neutrons. The beryllium, aluminium or other non-HTS material is optionally cryogenically cooled to reduce its resistance and is optionally joined to HTS material forming the remainder of the toroidal magnet apart from the central column. The HTS material may be configured to provide enhanced resistance to neutron damage and/or enhanced current density.

The neutrons emitted by the reactor may be used, inter alia, for generation of electricity, production of heat, formation of isotopes for medical and other use, cancer therapy, production of hydrogen (for example by high temperature electrolysis), treatment of nuclear waste, manufacture of tritium by neutron bombardment of lithium, breeding of nuclear fission fuel, neutron spectroscopy, testing of materials and components, and/or scientific research.

In conventional fusion reactors, a-particles generated in the plasma are retained. Although the invention described here is much smaller than a conventional fusion reactor, the a-particles will still be confined because of the high field, and will give a significant contribution to the plasma heating. Indeed, a-particles can be confined at much lower plasma currents than previously understood.

While the reactor is running, there should optionally be no solenoid in the centre of the torus, since it could be damaged by the high neutron fluence.

A feature of the present invention is that High Temperature Superconductor (HTS) is used in the main toroidal field magnet (and optionally in the other magnets), enabling high fields to be obtained at low operational cost in a compact ST. The combination of high field, small size and low aspect ratio (which provides improved stability and improved energy confinement) enables fusion energy to be realisable on a much smaller scale than in previous designs.

The HTS cryostat can be designed with or without liquid cryogens and the cryogens could be a range of molecules or compounds including He, H₂, Ne or N₂ depending on the temperature and cooling power required. The cryostat can also be designed to add structural strength and rigidity to the tokamak and the toroidal field coils.

The HTS can be manufactured from a range of materials including YBCO or (Re)BCO (where Re is a rare earth element) in the form of tape or wire with a range of substrates, stabilizers, buffers and overlayers in order to give the structural properties and engineering current density required.

The fusion reactor may include divertor plates optimised to reduce the load per unit area on the walls of the plasma chamber, and/or divertor coils configured to direct an exhaust plume of the plasma and expand a footprint of said exhaust plume to large radius and/or sweep the contact region over the exhaust area. One or more of the divertors may be coated with liquid lithium. The walls of the vacuum chamber may also be coated with liquid lithium.

The reactor may also comprise a multiplier blanket configured to increase the flux of emitted neutrons (at the expense of individual neutron energy). Reflector blankets may be provided to direct neutrons out of the reactor in such a way as to produce local increases in flux density and/or to protect poloidal coils and other tokamak components from extensive neutron irradiation.

The reactor may also comprise a sub-critical blanket of fissile or fertile (eg thorium) material forming a hybrid fusion-fission reactor. In this arrangement the copious quantities of neutrons produced by fusion will start and sustain a fission reaction and/or convert fertile isotopes to fissile isotopes. This arrangement can be use to breed new nuclear fuel, destroy nuclear waste and/or generate energy.

The invention also provides a power station comprising a plurality of fusion reactors as described above.

In accordance with another aspect of the present invention there is provided a method of generating neutrons or energy by operating a nuclear fusion reactor comprising a toroidal plasma chamber. The method comprises initiating a plasma in the plasma chamber, the plasma including tritium ions, generating a magnetic field with a toroidal component of 5 T or less, preferably 4 T or less, preferably 3 T or less, more preferably 2 T or less, and emitting neutrons and other energetic particles. The plasma is confined with a major radius 1.5 m or less, preferably 1.2 m or less, preferably 1.0 m or less preferably 0.8 m or less, more preferably 0.6 m or less. the plasma current is 5 MA or less, preferably 4 MA or less, preferably 3 MA or less, more preferably 2 MA or less, more preferably 1 MA or less. The aspect ratio is 2.5 or less, preferably less than 2.2, more preferably less than 2.0, more preferably less than 1.8, more preferably less than 1.7. A fraction of a-particles generated in the reactor which are confined within the plasma is 0.4 or greater, preferably 0.5 or greater, more preferably 0.6 or greater, more preferably 0.7 or greater, more preferably 0.8, more preferably 0.9 or greater

### BRIEF DESCRIPTION OF THE DRAWINGS

Some preferred embodiments of the invention will now be described by way of example only and with reference to the accompanying drawings, in which:

FIG. 1 illustrates the magnetic field line behaviour in conventional and spherical tokamaks;

FIG. 2 is a half cross-section through a spherical tokamak with conventional copper magnets;

FIG. 3 shows the structure of one example of HTS material;

FIG. 4 shows a quarter cross section through a spherical tokamak with HTS toroidal field magents with limited neutron shielding and different configurations of the central column to provide more resilience to neutron bombardment;

FIGS. 5A and 5B show simulations of trajectories of fast ions produced by the injection of 100 kV beams in an ST CFNS;

FIG. 6 shows the dependence of alpha particle containment on the plasma current in a low aspect ratio compact reactor, using the guiding centre approximation;

FIG. 7 shows the variation of alpha containment with aspect ratio and elongation, keeping the minor radius the same;

FIGS. 8A-8E show alpha particle orbits in ST FNS, R/a=0.5/0.3 m, k=2.75, Iₚ/Bₜ=1.5 MA/1.5 T for different birth locations of alphas;

FIGS. 9A and 9B show alpha containment fraction and wall loading in a ST pilot plant;

FIGS. 10A and 10B show alpha power deposition in a compact ST reactor at plasma currents of 4 MA and 6 MA;

FIG. 11 shows full gyro-orbit simulations of alpha power deposition in the compact ST reactor for plasma currents of 3 MA, 4 MA and 6 MA;

FIGS. 12A and 12B show TFTR geometry as used in simulations and normalised poloidal distribution of the lost alpha particles wall load;

FIG. 13 shows a normalised poloidal distribution of the lost alpha wall load in the compact ST reactor; and

FIGS. 14A-14D show how ash builds up over time and the resulting reduction in fusion power for STPP, ITER and the compact ST pilot plant.

### DETAILED DESCRIPTION

The present application is based on a very compact form of the tokamak, and employs a range of innovative features, including optimisation of alpha confinement at surprisingly low plasma currents. The ‘Efficient Compact Fusion Reactor’ (ECFR) is intended to provide a compact fusion power plant.

Fusion neutrons are produced when a deuterium-tritium (D-T) or deuterium-deuterium (D-D) plasma becomes very hot so that the nuclei fuse together, releasing energetic neutrons. To date, the most promising way of achieving this is to use a tokamak; in the conventional tokamak approach to fusion (as embodied by ITER), the plasma needs to have high confinement time, high temperature, and high density to optimise this process.

A tokamak features a combination of strong toroidal magnetic field B_{T}, high plasma current Iₚ and usually a large plasma volume and significant auxiliary heating, to provide a hot stable plasma so that fusion can occur. The auxiliary heating (for example via tens of megawatts of neutral beam injection of high energy H, D or T) is necessary to increase the temperature to the sufficiently high values required for nuclear fusion to occur, and/or to maintain the plasma current.

The problem is that, because of the large size, large magnetic fields, and high plasma currents generally required, build costs and running costs are high and the engineering has to be robust to cope with the large stored energies present, both in the magnet systems and in the plasma, which has a habit of ‘disrupting’—mega-ampere currents reducing to zero in a few thousandths of a second in a violent instability.

The situation can be improved by contracting the donut-shaped torus of a conventional tokamak to its limit, having the appearance of a cored apple—the ‘spherical’ tokamak (ST). The first realisation of this concept at Culham demonstrated a huge increase in efficiency—the magnetic field required to contain a hot plasma can be reduced by a factor of 10. In addition, plasma stability is improved, and build costs reduced.

A drawback of the ST is that the limited space in the central column prohibits installation of the substantial shielding necessary to protect the central windings in a neutron environment—so conventional toroidal field windings, and conventional central solenoids (used to induce and maintain the plasma currents) are not practical. Although power plants based on the ST have been designed (using solid copper centre posts with limited shielding, the post being changed every year or so when damaged by neutrons), these have high energy dissipation in the centre column due to the relatively high resistivity of warm copper, requiring a large device for electricity production to become economical.

An important factor is the strength of the toroidal magnetic field, B_{T}. Fusion power from thermal fusion in a tokamak is proportional to the fourth power of B_{T} and so tokamaks are designed to use the maximum possible B_{T} consistent with the significant stresses this imposes, and the significant costs of electricity required to power these magnets. To minimize these costs, long-pulse modern devices such as ITER feature LTS magnets cooled by liquid helium.

The present limit of the high-field approach is exemplified by the medium-sized IGNITOR project, now under development as a joint Russian—Italian project: IGNITOR is predicted to achieve short pulse ignition without need of extensive auxiliary heating, by virtue of its very high field B_{T}, ˜13 Tesla at the plasma major radius (1.43m) and ˜20 T at the edge of the centre stack, obtained by conventional copper magnets with a steel support structure.

A drawback of the ST approach is that due to the reduced space in the centre column the toroidal field magnet therein is of limited size and so only relatively low toroidal fields of less than 1 Tesla have been achieved in STs to date. This problem is overcome in ECFR by use of High Temperature Superconducting magnets.

A smaller scale approach to fusion is to use the effect first suggested by Jassby [1] whereby injection of a high energy neutral beam into a small, merely ‘warm’, plasma can also produce significant fusion power. This effect combined with an ST, is the basis of our design for a ‘Super Compact Neutron Source’ (SCFNS) which has B_{T}=1.5 Tesla [2].

The power (P_{fus}) produced by SCFNS operating with D-T fusion is estimated at 1-2 MW, whereas input power (P_{NBI}) is ˜6 MW of NBI; hence Q (P_{fus}/P_{NBI}) ˜0.25, although Q_{eng} (P_{fus}/Pₜₒₜₐₗ) is ˜0.05 since to create 6 MW of NBI requires ˜18 MW of electricity; and about a further 10 MW is lost in dissipation in the copper magnets. Production of net electrical power from fusion requires Q_{eng}>1. Nonetheless SCFNS produces significant fusion power for a small device, and the 14 MeV neutrons can have many valuable applications that compensate for the low efficiency of conversion of electrical power input to fusion power output.

Until now it has been thought that this smaller scale approach could not lead to an economic fusion energy power plant, as the input neutral beam injection (NBI) power is relatively large and the magnetic fields are not sufficient to contain the hot, charged alpha particles produced by fusion reactions within the plasma, which therefore loses the self-heating they could provide, and which is a key feature of conventional tokamak designs aimed at fusion power production. However recent advances in technology may enable these small STs to achieve high magnetic field, as described below.

High Temperature Superconductors

Recent advances in high temperature superconductors (HTS) have far-reaching consequences for fusion. Whereas conventional low temperature superconductor (LTS) magnets use temperatures in the liquid helium range (˜4K), HTS can give similar results at the more convenient and easier to achieve liquid nitrogen temperature of 77K or even higher.

But the advantages of HTS far exceed cost and convenience. If HTS is actually operated at lower temperatures than 77K, the current-carrying ability is greatly increased, and the conductor can operate in much higher fields. Indeed, Oxford Instruments have recently demonstrated an HTS magnet producing nearly 23 T, exceeding the 20 T maximum achieved by LTS (actually done by inserting an HTS core into an LTS outer).

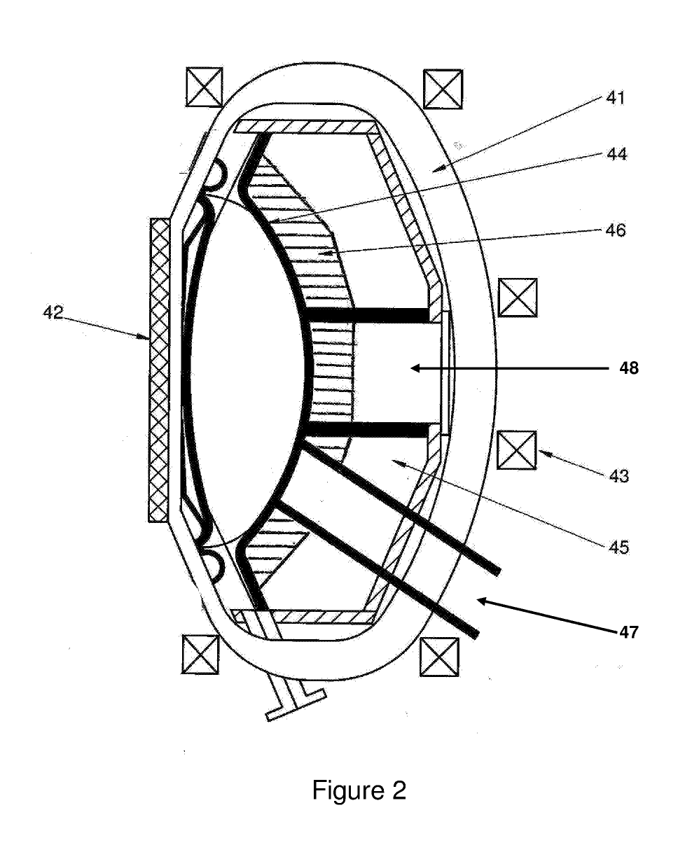

The combination of higher maximum field, increased current-carrying capability and reduced complexity of cooling means that very high toroidal field HTS magnets may be possible in the limited space of a Spherical Tokamak core. For example, if 30 T is feasible at the edge of the centre column (as suggested from FIG. 2), this would give 12 T at the major radius of an ST of aspect ratio 1.66 such as SCFNS. Fusion power in a beam-driven device such as SCFNS has been observed to be approximately proportional to B_{T} cubed [3]. This implies that by increasing B_{T} from 1.5 T for the existing SCFNS design to 12 T for the high field version described here, the fusion power would be increased approximately by 12/1.5 cubed, i.e. by 512; so Q_{fus}˜128, Q_{eng}˜38; and all in a small device! An additional benefit is that at these high fields, the charged alpha particles produced during the fusion reaction will remain in the plasma, providing significant self-heating and further increasing the efficiency of the reactor. Work by Jassby [1] showed that there is a fundamental limit to the efficiency of idealised beam-plasma fusion at around Q_{fus}˜3 so while this would still allow a highly efficient neutron source from a small device, it is not a viable approach for energy production. However at the high fields now envisaged we obtain higher confinement, higher plasma temperatures and hence a combination of beam plasma fusion and thermal fusion, possibly purely thermal fusion without need for neutral beam heating.

The maximum achievable thermal fusion power is well known to be proportional to the 4^{th} power of toroidal field [5]. In fact it is proportional to β²β_{T}⁴V where β is the normalized plasma pressure and V is the volume. The β limit is 4 to 5 times higher in a spherical tokamak than in a conventional low aspect ratio tokamak, so if B_{T} can be as high as 12 T or more, and high plasma pressures can be obtained, then high thermal fusion power is possible even from a small spherical tokamak. For example, ITER is expected to produce 500 MW of fusion power with a toroidal field of 5.5 T. A spherical tokamak with twice the toroidal field and 4 times higher β should be able to produce the same power in 1/256 of the volume.

High Temperature Superconducting technology continues to advance rapidly. The first generation HTS material, BSCCO, was rapidly overtaken by YBCO. As well as the discovery of new HTS materials with fundamentally higher critical fields and critical currents, the engineering performance of existing materials such as YBCO (or, more generally (Re)BCO where Re is a rare earth atom) is rapidly being improved with the result that magnets made from HTS can achieve increasingly high fields from increasingly small conductors. In the present specification, it will be understood that HTS materials include any material which has superconducting properties at temperatures above about 30 K in a low magnetic field.

The performance of HTS under intense high energy neutron bombardment is not yet known, however there are concerns that it will need more than 10 cm of shielding in order to remain effective for months or years of operation. This amount of shielding may be too large to accommodate around the central column of a small spherical tokamak. Several alternative means may be utilized to allow a high current to pass through the central column.

FIG. 3 is a schematic illustration of the components of standard HTS tape 500. Such tape 500 is generally approximately 100 microns thick, and includes an electropolished hasteloy substrate 501 approximately 50 microns thick, on which is deposited by IBAD or magnetron sputtering a series of buffer stack layers 502, each approximately 0.2 microns thick. An epitaxial (RE)BCO-HTS layer 503 (deposited by MOCVD) overlays the buffer layer, and is typically 1 micron thick. A two micron silver layer 504 is deposited on the HTS layer by sputtering, and 20 micron copper stabilizer layers 505 are electroplated onto both sides of the tape. In order to increase the current in the tape, the thickness of the HTS layer may be increased from around 1 micron to between 4 and 20 microns. This increases the current that can be carried by a factor of between 2 and 5 [20] and increases the neutron tolerance by a factor of between 4 and 20. As mentioned above, the overall tape thickness is normally 100 microns, so if this is the only change made, the increase in tape thickness will be less than 20%.

Another approach is to reduce the thickness of the copper 505 and hasteloy 501 layers (or other conducting/supporting non-HTS layers in the tape). Halving the thickness of these non-HTS layers approximately doubles the current density in the tape, allowing more space for shielding.

A third approach is to use a cryogenically cooled beryllium or aluminium central post in the spherical tokamak instead of HTS as shown in FIG. 6 option B. There would be undesirable resistive losses in the beryllium or aluminium, but these can be minimized by cooling, ideally to 30K or lower and by connecting the beryllium or aluminium central post to HTS outer arms of the toroidal field coils. Beryllium or aluminium is chosen because it has low resistivity at temperatures of 30K or lower and because it is resistant to damage from high energy neutrons. Other elements or materials with these properties, or similar properties, could also be used.

A fourth means is to use a combination of an outer cryogenically cooled beryllium or aluminium central post with an inner part made of HTS as also shown in FIG. 6 option

C. The beryllium or aluminium outer provides some shielding of the HTS. Cooling, ideally to 30K or lower, and connecting the beryllium or aluminium/HTS central post to HTS outer arms of the toroidal field coils is still necessary to minimize resistive losses.

A combination of these techniques, for example the first, second and fourth means, could be used.

For an efficient ST fusion neutron or energy source to be practical it is desirable to solve the following problems:
Initiating the plasma current without a conventional central solenoid.
Ramping up the plasma current to the required value.
Maintaining the plasma current for a long time with low power input.
Heating the plasma to produce neutrons at low power input.
Confining alpha particles within the plasma.
Ensuring that the heat load from the plasma on the divertor regions is tolerable.
Designing a structure capable of protecting itself against neutron damage, whilst producing a fluence of neutrons for energy production or for scientific and other applications.

Previous Studies of ST-Based Fusion Devices

Before describing the device in detail, it is helpful to consider previous studies of fusion devices based on spherical tokamaks.

Stambaugh et al [5] in ‘The Spherical Tokamak Path to Fusion Power’ described a family of Spherical Tokamaks (STs) including a Pilot Plant with major radius of R˜0.7 m (plasma current Ip˜10 MA , central toroidal field B_{To} ˜2.8 T) which have significant output (400 MVV) at an optimistically high H-factor (increase in energy confinement over scaling law for conventional tokamaks) ˜7 and β_{T} (measure of efficiency: the ratio of plasma pressure contained to magnetic field pressure required) 62% and a wall loading of 8 MW/m2 (wall assumed to be at radius Ro+2a) and which are designed to produce electricity economically.

Hender et al [6] considered a Component Test Facility (CTF) based on a similarly modest sized ST (R˜0.7 m, Ip˜10.3 MA, BTo˜3 T, fusion output˜40 MW at a modest H-factor˜1.3, β_{N}˜2.6 and wall load (at Ro+2a) of ˜0.75 MW/m2) designed to produce sufficient neutron fluence to test fusion reactor components.

Wilson et al [7] extended the work of Hender et al to propose a CTF again of A˜1.6, designed to consume <1 kg of tritium per year and specifically to aid the fast-track approach to fusion power by testing components and materials. Their device has R˜0.75 m, Ip˜8 MA, BTo˜2.8, H˜1.3, PNBI˜60 MW, and yields Pfus˜50 MW of which about 25% arises from beam-plasma interactions (discussed further below).

Voss et al [8] developed the Wilson design, increasing the size slightly to R=0.85 m, a=0.55 m, with a slight decrease in current and field to 6.5 MA and 2.5 T, again assuming H=1.3 ,with PNBI=44 MW and Pfus=35 MW.

Dnestrovkij et al [9] provided a DINA code simulation of the Wilson CTF, and find by using a different mix of NBI energies (6 MW at 40 keV and 44 MW at 150 keV) they can provide current ramp—up and, aided by a larger tritium fraction of 70% (cf 50%) obtain the same fusion output (50 MW) but at considerably lower plasma current (5.5 MA cf 8 MA). Although tritium is scarce and expensive, the option of using a larger tritium fraction to obtain the same neutron output but at lower plasma pressure (and hence improved plasma stability) is attractive.

Peng et al [10] proposed a larger CTF with R=1.2 m, A=1.5, k=3.07, Bt=1.1-2.2 T, Ip=3.4-8.2 MA, heating power 15-31 MW, bootstrap (self-driven current) fraction ˜0.5, Q (ratio of fusion power out to input power)=0.5-2.5, Pfus=7.5-75 MW. This CTF also has an option of tritium breeding.

Galvao et al [12] studied a ‘Multi functional Compact Tokamak Reactor Concept’ a device of major radius Ro=1.2 (some 50% larger than MAST and NSTX), with A=1.6, Ip=5 MA, BTo=3.5 T, and obtained a fusion gain (Q)˜1 for a range of auxiliary heating powers from 5 MW to 40 MW. Interestingly, at lower powers the maximum Q˜1 gain occurs at ever lower densities, whereas bootstrap current increases almost linearly with density—so the higher performance options have the advantage of largest self-driven current. However this study did not consider the additional neutron production provided by beam-plasma interactions.

More recently, Kotchenreuther et al [11] proposed a larger Fusion Neutron Source with 100 MW fusion output (Ro=1.35m, aspect ratio 1.8, BTo=3.1 T, Ip=10-14 MA) using their ‘Super X’ divertor to solve the critical divertor thermal load problem. Their device is designed for use either as a CTF, or as the basis of a fusion-fission hybrid.

All the above studies employ NBI for current drive and heating, in conjunction with α—particle heating (note a-particles have low prompt losses at the high plasma currents employed in the above studies). They use well-understood technology (e.g. copper windings), and aspect ratios 1.4-1.6 (at which sufficient tritium can be bred without need of a centre-column blanket).

Recently, smaller, lower power compact fusion neutron sources have been proposed, with modest fusion outputs of 1-2 MW. Their requirements are significantly less demanding than those in the above studies, especially the Stambaugh et al study which requires long-pulse operation close to stability limits and at high wall-loading to ensure cost-effective electricity production. Hender and Wilson require high neutron flux for long periods to provide sufficient component testing, and operate at high plasma current. In these recent proposals, demands on physics limits and on engineering are much reduced, however a useful fusion power should be obtainable.

Two recent studies are particularly relevant:

Kuteev et al [13] specifically addressed the need for a small facility developing up to 10 MW of fusion power whilst requiring total auxiliary heating and current drive power<15 MW and total power consumption<30 MW. They re-evaluated the smallest (Ro˜0.5 m) member of the Stambaugh range but under extremely reduced conditions: Ip˜3 MA, BTo˜1.35 T with a neutron fluence of ˜3×10¹⁷ n/s corresponding to a fusion power of ˜1 MW and a neutron load 0.1 MW/m². Modelling shows that neutron production is more than doubled by the beam-on-plasma effect. Importantly for a first pilot device, the build cost was estimated at less than £200 M.

Thus rather than operating at high plasma current, it may be possible to employ significant NBI auxiliary heating and enjoy significant neutron production from the NBI beam-on-plasma interactions noted by Jassby [1]. This effect occurs when injected beams slow down in a thermal tokamak plasma, and is effective in the ST plasmas considered here.

Sykes et al [2] develop the beam-plasma fusion concept and propose a small spherical tokamak (SCFNS=Super Compact FNS) with fusion power (dominated by beam-plasma fusion) of 1-2 MW. SCFNS has parameters R˜0.5m, with Ip=1.5 MA (half that of the Kuteev design), and BT=1.5 T. A neutral beam power of only ˜6 MW is sufficient to both maintain the plasma current, and to provide the fusion power; this low input power reduces the wall and divertor loadings to tolerable values, so that techniques developed for ITER can be utilised.

The spherical tokamak represents a low aspect ratio version of a conventional tokamak and is a crucial component of the present invention.

The concept of a spherical tokamak (ST) was first introduced by Jassby [14] and later by Peng [15]. At the same time, a small low-aspect ratio tokamak GUTTA was constructed and operated at loffe Institute, Russia, confirming some of unique features of the ST concept. The first demonstration of the main advantages of a spherical tokamak (i.e. high beta, high natural elongation, improved stability and enhanced confinement—H-mode) was on the START device [16] which was operating at Culham Laboratory 1990-1998. START was a small tokamak but achieved normalised plasma pressures βₜ˜40% (which is still a record for tokamaks). In the ST the aspect ratio A of the plasma column is substantially reduced with respect to conventional tokamak aspect ratio range (A≈3-4), giving significant improvements in plasma stability. The combination of simple construction, excellent results and high reliability confirmed on more than 15 small and medium sized STs operated during the last decade produce a strong motivation for an ST as the next step in fusion research, and the high performance and small size makes the ST economical both in build cost and in tritium consumption (if D-T operation is desired).

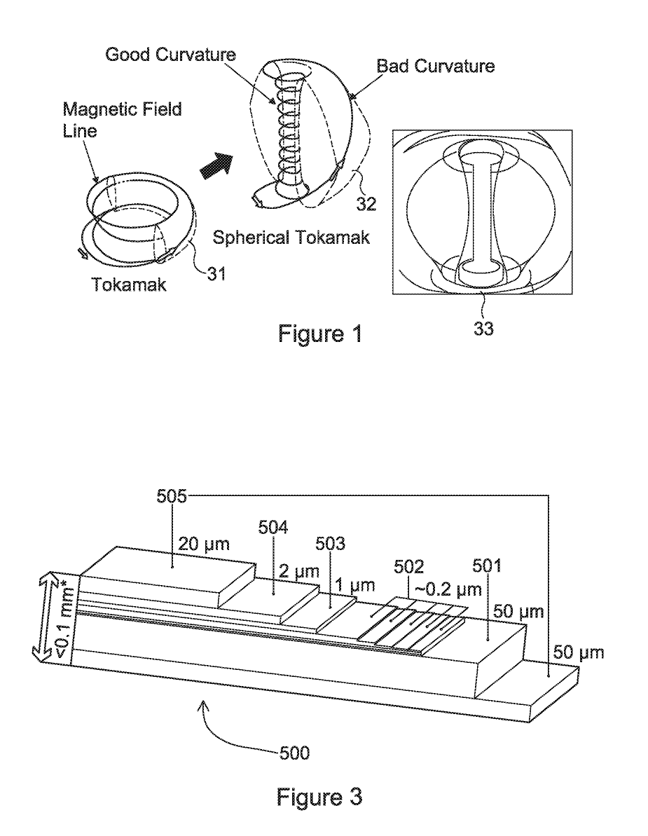

FIG. 1 (courtesy of Y-K M Peng) illustrates an effect of aspect ratio reduction. The figure shows the peripheral magnetic field lines in a conventional tokamak 31 and in a spherical tokamak 32. In the conventional tokamak 31, magnetic field lines have comparable lengths in the region of a favourable curvature (inner, high field and stable region) and unfavourable curvature of magnetic field (outer unstable region). In the spherical tokamak 32 the field line path in the inner, stable region is significantly higher than in the outer, unstable region and the field line is generally wrapped onto the central core of the plasma, where the toroidal magnetic field is highest. As the particle motion in a magnetic trap is bound to the field lines, the most straightforward result of an aspect ratio decrease is an increase in the plasma column magneto-hydrodynamic (MHD) stability. This improved MHD stability permits either a significant increase in the plasma current, or a decrease in the toroidal magnetic field strength, this feature has been exploited in the successful ST experiments, notably START at Culham [16]. The figure shows the plasma 33 in the START tokamak, with sharp plasma edges, demonstrating the excellent confinement properties (H-mode) obtainable in an ST plasma.

In addition, simulations of fast particle physics indicate that compact high field STs can be optimised for energy and neutron production by controlling the alpha particle containment. For low-current and low-power cases, typical for a compact ST fusion neutron source, alpha particle losses may result in a significant heating and erosion of the first wall. As the alpha particle containment depends mainly on the poloidal magnetic field, optimisation of the minimal plasma current for an efficient heating in a compact ST Pilot plant is important. For high-current, high power cases, relevant to ST reactors, when alphas are not lost and provide the main plasma heating, the problem of dilution in fusion reactors is known to play a substantial role. However, accumulation of the He ash, which is responsible for the dilution, significantly reduces in a compact low-power ST reactor.

Recent simulations show that the plasma current required to confine alpha particles in ST reactors is lower than has previously been realised. The Monte-Carlo procedure in the code NFREYA [22-24] uses the pseudocollision technique. The mean free path length for both, pseudo and real collisions, is the minimum free path length λₘᵢₙ for real collisions. The introduction of pseudocollisions allows the plasma to be treated as a medium with constant attenuation length. The mean free path length due to pseudocollisions, λ_{pseudo,} is defined in the total plasma volume by

$$\frac{1}{{λ}_{pseudo}} = \frac{1}{{λ}_{m i n}} - \frac{1}{{λ}_{chex}} - \frac{1}{{λ}_{ion}}$$

λ_{chex} and λᵢₒₙ are the local mean free path lengths due to charge exchange and impact ionization by electrons and ions. Since normally λ=λₘᵢₙ at the plasma centre, we have there

$$P = \frac{1}{{λ}_{pseudo}} = 0$$

and P increases towards the plasma boundary. In the vicinity of the plasma boundary pseudo collision must be added to maintain the same mean free path length as at the center. The number of real collision depends on the deposition profile. The charge exchange, electron and ion ionization cross-sections are taken from [25].

The Fokker-Planck equation is obtained from the Boltzmann equation under the assumption that only small scattering processes are important [26]. In the case of an inverse-square force of the interacting particles the Rosenbluth potentials can be introduced [27]. Using the approximations in [28] and the extensions proposed in [29] a partial differential equation for the time evolution of the distribution function ƒ of the fast particles can be obtained:

$${τ}_{s} \frac{\partial f}{\partial t} = {T}_{cex} + {T}_{diff} + {T}_{pitch} + {T}_{{drag}_{e}} + {T}_{{drag}_{i}} + {T}_{source}$$

The characteristic time is the slowing down time τₛ [29]. The terms T_{cex}, T_{diff}, T_{pitch}, T_{drag}, T_{source} are up to 2^{nd} order differential operators applied on ƒ in velocity space. They account for the charge exchange, the energy diffusion, the pitch angle scattering, and the drag by electrons (T_{drag}_{ₑ}) and ions (T_{drag}_{ᵢ}). T_{source} accounts for the source in velocity space [5, eq. 22]. It is a δ-function 8(v-v₀) (in the absolute value v of the of the speed vector, v₀ is the beam velocity) whereas the angular distribution follows from the injection geometry [22]. In the case of the alphas the angular distribution is isotropic. The strongly implicit procedure ‘SIP’ [30] is used to solve the finite difference equation approximating the Fokker-Planck equation.

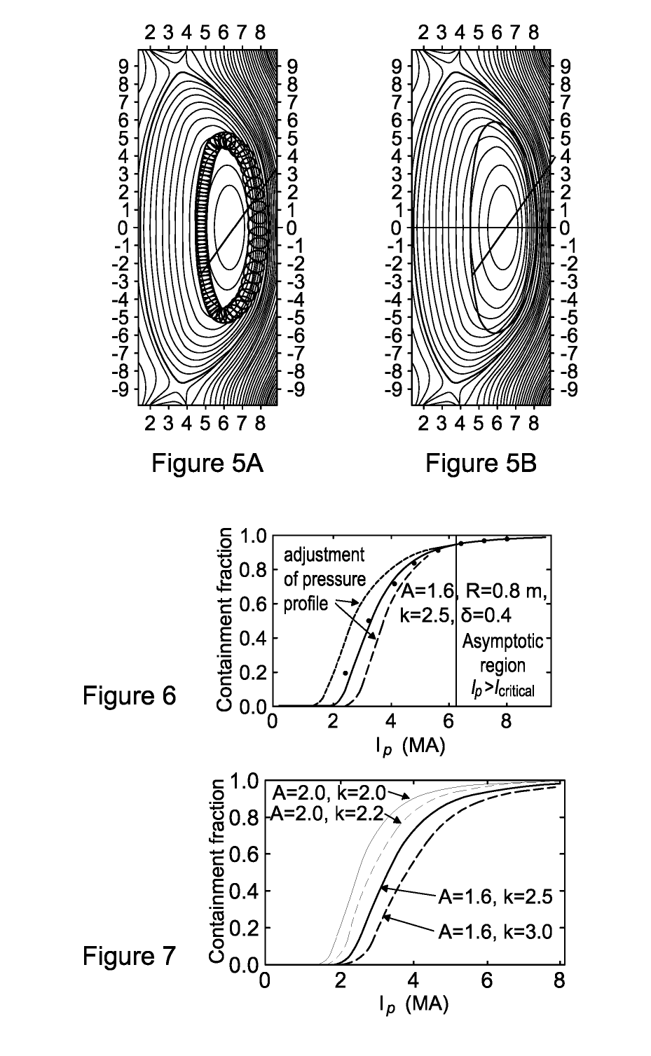

The ST geometry is shown to affect fast ion losses in both full orbit and drift orbit guiding centre losses approaches. To ease the self-consistent transport simulations, the guiding centre approach would be beneficial and save computational time, so it is important to understand the limits of this approach. Simple analytical formulas are typically used in system codes for predictions of a reactor performance. An example of trajectories of fast ions produced by the injection of 100 kV beams in an ST CFNS [31] with Iₚ=1.5 MA, Bₜ=1.5 T, R/a=0.5/0.3 m, k=2.75 are presented in FIGS. 5A and 5B. FIG. 5A shows full gyro-orbit simulations and FIG. 5B shows the guiding centre approximation. The line shows the direction of the injection. Table 1 shows results of comparison of the fast ion deposition for the full-orbit and guiding center simulations for neutral beam power P_{NBI}=10 MW and nₑ=1.5×10²⁰ m⁻³ (other details are described in [22]) for three beam energy components for this device, h₁ₘₐₓ, h₂ₘₐₓ and h₃ₘₐₓ.

TABLE 1
Comparison of the fast ion deposition for the full-orbit and
guiding center simulations for ST FNS, first two rows,
and a device with similar parameters, but with
R₀ increased to 1.5 m, third and fourth rows.

| Orbit | h₁ₘₐₓ | h₂ₘₐₓ | h₃ₘₐₓ |
|---|---|---|---|
| Guiding Center | 3.44 | 3.14 | 2.69 |
| Full Gyro | 3.01 | 1.91 | 1.35 |
| Guiding C. A = 5, R₀ = 150 | 2.48 | 1.63 | 1.51 |
| Full Gyro A = 5 | 1.32 | 1.58 | 1.40 |

It is seen that for the main component, h₁ the difference is only about 15%, which justifies the use of the simple guiding centre model for preliminary estimates for the case of the CFNS, first two rows, as the main power is deposited through the first component [22]. To illustrate the role of the aspect ratio, simulations were also performed for a high aspect ratio tokamak with R/a=1.5/0.3 m, third and fourth rows, and with all other parameters the same as for the ST CFNS. For the high aspect ratio, but still compact device, the difference is much more significant and the use of the full gyro-orbit model should be recommended. It is noted that the difference will be much less for bigger devices when the orbit radius is much smaller than the device cross-section, so the need for full-orbit simulations is connected with the small poloidal cross-section of compact devices.

However, for the alpha particles studies, results appeared to be quite cifferent. It is typically assumed that to confine 3.7 MeV alpha particles, a plasma current of around 5-6 MA is needed. Simulations using simple formulas [12] show a sharp reduction of alpha containment when the plasma current is reduced below this level. This behaviour does not depend much on the device geometry and plasma parameters. FIG. 6 illustrates the dependence of the alpha particle containment on the plasma current in a low aspect ratio compact reactor with R₀=0.8 m, A=1.6, k=2.5 [12]. Here the asymptotic expression of first-orbit loss model has been used, with dashed lines presenting variation of the broadness of the pressure profile, which is measurable, but not significant. FIG. 7 shows results of the variation of the aspect ratio and elongation, keeping the minor radius the same. Again, the sharp reduction of the containment with the plasma current is seen.

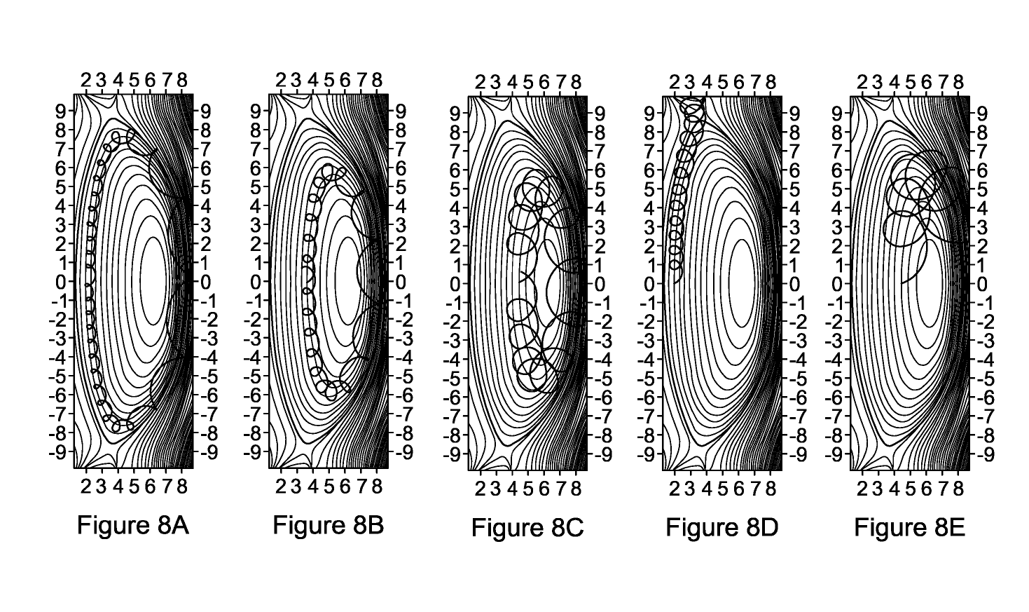

These results can be compared with those obtained by the guiding orbit and full gyro-orbit model in a Monte-Carlo code, using about 60000 particles. To illustrate the strong dependence of the alpha trajectory on the birth point in ordinary and velocity space, we FIGS. 8A-10E show results of simulations for for different birth locations of alphas, i.e. for cases when alphas are confined (FIGS. 8A-8C) or not confined (FIGS. 8D, 8E). The plasma is that of the ST CFNS with the same parameters as used for the fast ion studies (R/a=0.5/0.3 m, k=2.75, Iₚ/Bₜ=1.5 MA/1.5 T). However, it is more important to perform detailed analysis for higher currents, when alphas are better confined.

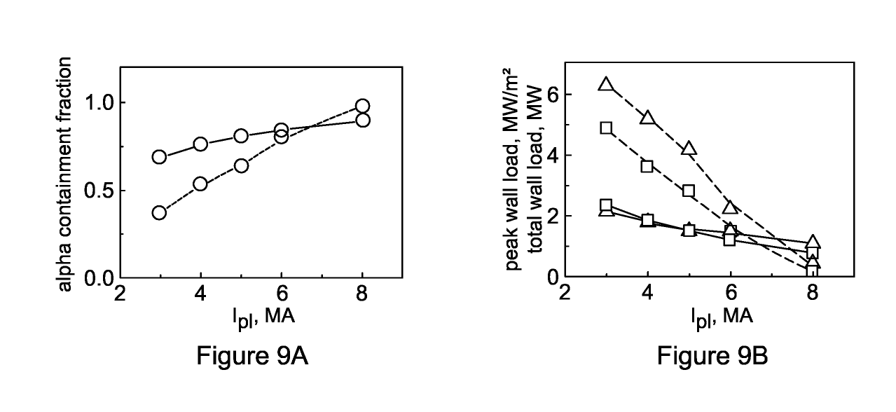

FIG. 9A shows comparison of the alpha containment calculated with the full gyro-orbit model (solid dots) and a guiding center approximation (open dots), for a compact ST pilot reactor with R/a=0.6/0.4 m, k=3, Bₜ=5 T. In the full-orbit case, the reduction of the containment is much less steep, because at large currents (even 8 MA) the gyrating particle—in contast to the guiding centre particle—occupies a cylinder-like volume. This volume, characterized by the Larmor radius, touches the boundary at a distance of a Larmor radius already, thus producing more losses than the guiding center particles. At lower current (3 MA) the guiding centre drift in the vicinity of the axis of symmetry is—due to the approximations—overestimated. Thus more guiding center particles than gyro—particles are lost. FIG. 9B illustrates the alpha wall loading for the same ST. The triangles represent the peak load and the squares the total load.

The conclusion of these studies is that to calculate losses and deposition profiles in a compact ST, the full-orbit model should be used, which shows less steep dependence on the plasma current. This is very promising, as any reduction in the plasma current will improve the economics of a compact ST reactor.

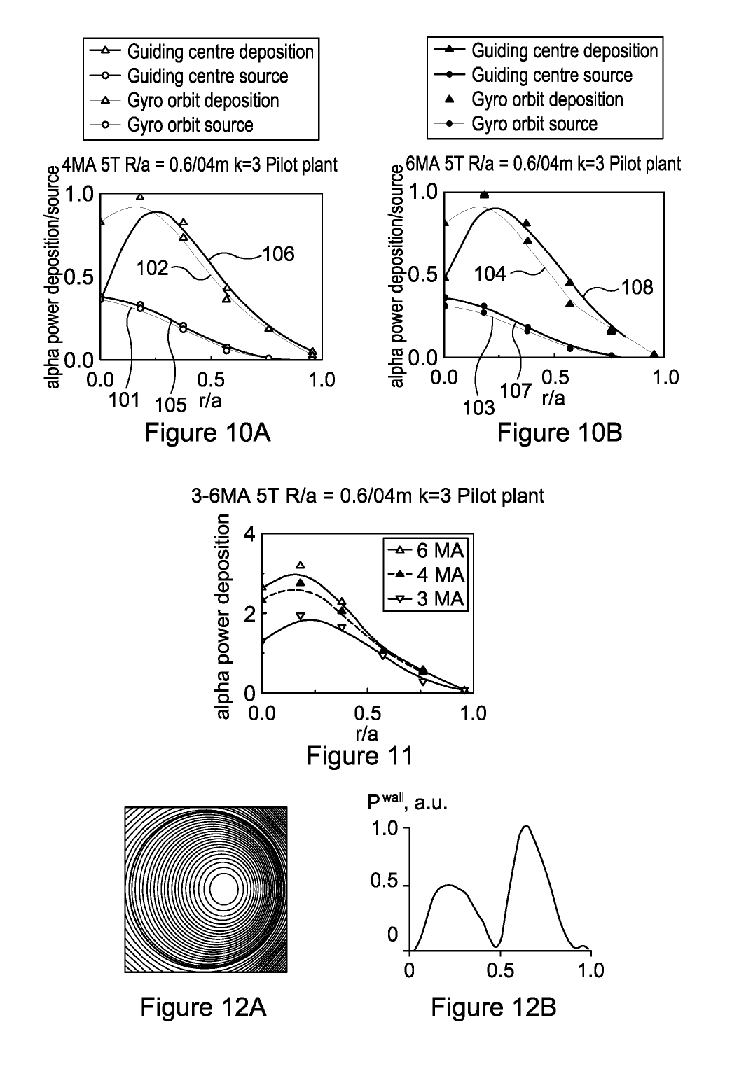

Using the approach described above, the alpha power deposition and losses in a compact ST reactor can be calculated. FIGS. 10A and 10B present normalised alpha power deposition profiles in the compact ST reactor described above. In FIG. 10A Iₚ=4 MA, and in FIG. 10B Iₚ=6 MA, with the gyro orbit model shown by lines 101, 102, 103, 104 and the guiding centre approximation as lines 125, 126, 127, 128. Lower curves (dots) show thermonuclear source profiles. Apart from the expected difference at the magnetic axis, both methods give similar profiles for both 4 MA and 6 MA.

FIG. 11 shows results of the full gyro-orbit simulations of alpha power deposition in the compact ST reactor for Iₚ=3 MA, 4 MA and 6 MA. Deposition profiles for 4 and 6 MA are practically very close, which is very encouraging. However, it will be appreciated that reduction in the plasma current may result not only in the reduction of the fusion power, but also in a significant increase in the wall load due to lost alpha particles. Calculations of the wall load are quite complicated, as the load and specifically the poloidal distribution of the load depend on the real geometry of the vessel and a gap between the wall and plasma. This becomes even more complicated if the guiding center model is used. It can be seen from FIG. 10B that the guide centre model significantly overestimates the wall load, consistent with the overestimation of the losses shown in FIG. 9A. Apparently, the weak current dependence of the ‘gyro’ containment is transferred to a weak loading dependence of the ‘gyro’ loading. Analogously, the strong dependence of the guiding centre loading follows from the respective containment. The guiding centre approximation gives a considerable difference to the more accurate full orbit model, so it should be used with caution for a compact ST device.

Although both Monte-Carlo and Fokker-Plank codes used in the simulations above have been benchmarked with experimental data and other codes (see [5] for references), experimental data on the alpha wall load is very limited. TFTR data [32] was used to benchmark the tools. FIG. 12A shows the TFTR geometry as used in the simulations, and FIG. 12B shows normalised poloidal distribution of the alpha particle wall load, for typical TFTR DT experiment conditions [32] with n_{d}=nₜ=1.6×10²⁰/m³, T₁₀=10 keV, R/a=2.48/0.85 m, Bₜ=5.2 T, I_{pI}=2.5 MA wall radius 1.10 m. The maximum wall load local loading at around 117° in these simulations was 1×10¹⁵ n/m², while Hively [32] gives 9.2×10¹⁴ n/m², which can be taken as a good agreement.

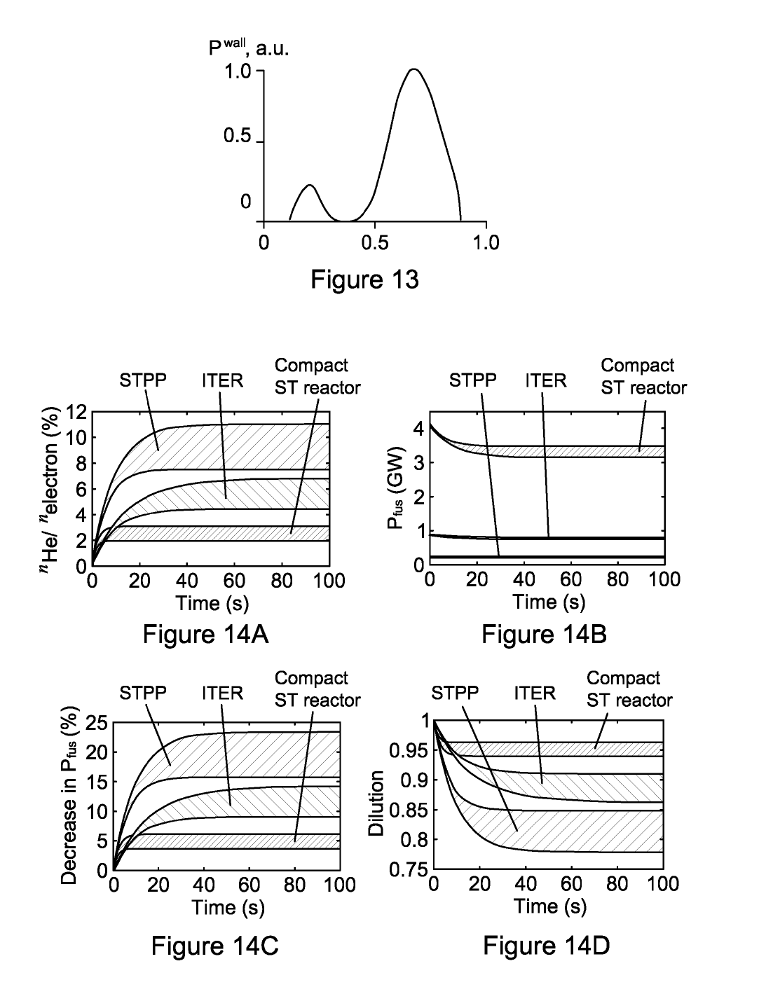

The distribution of wall load in a compact ST reactor can then be estimated. FIG. 13 shows the normalised poloidal distribution of the lost alpha wall load in the compact ST reactor using the full gyro-orbit simulations for typical plasma parameters [21] with the fusion power ˜60 MW. The lower plasma current case, Iₚ=4 MA is particularly noteworthy. As with the TFTR case, the small peak at X=0.2-0.3 comes from co-running alphas, and the big peak at X=0.7 (corresponding to poloidal angle) θ=106° from counter-running. The peak load was 0.8 MW/m² and the total load 2.62 MW. This is a tolerable, but not a negligible wall load and should be taken into account in detailed calculations of the wall cooling (or heating) arrangements. As the operation wall temperature of the reactor will be determined by the material neutron and heat load constraints (e.g. in the range of 300-400° C.), it is not obvious in a low-power reactor whether extra cooling or extra heating of the wall will be required.

Finally, the helium ash accumulation can be calculated in a bigger, but still compact ST reactor (R₀=1 m; B_{T}=5 T) [21] and compared to the larger ITER [33] and STPP [6, 7] devices. This can be done by assuming that the alpha confinement time (τ_{α} is some factor R larger than the energy confinement time (τ_{E}) and throughout a discharge the density is fixed at some fraction of the Greenwald limit. The He ash accumulation can then be modelled by solving the initial value problem:

$$\frac{d [ {n}_{α} ]}{d t} = [ {( \frac{{n}_{DT}}{2} )}^{2} 〈 σ v 〉 ] - \frac{1}{R {τ}_{E}} [ {n}_{α} ]$$

where square brackets represent an integral over the plasma volume and the initial condition is that there is no ash in the plasma. The first term on the right hand side represents the rate of the ash being created by fusion reactions and the second term represents the rate of ash being lost. Typically R (R=τ_{α}/τ_{E}) is found to be approximately 4 [7], but to represent this uncertainty a range of R′s from 3 to 5 was used. It is found that the resulting ash reduces the fusion output of a reactor by diluting the DT fue.

FIGS. 14A to 14D show how the ash builds up over time and the resulting reduction in fusion power for STPP, ITER and the compact ST pilot plant. FIG. 14A shows the accumulation of He ash, FIG. 14B shows the fusion power, FIG. 14C shows the decrease in fusion power compared to no ash, and FIG. 14D shows the dilution. Table 2 shows main parameters of devices used for calculation of alpha accumulation.

TABLE 2
Parameters of devices used for calculation of ash accumulation.

| | STPP | ITER | Compact ST |
|---|---|---|---|
| τ_{E} | 2.6 | 3.7 | 0.512 |
| pₒ | 0.5 | 0.5 | 0.25 |
| pτ | 0.25 | 0.25 | 1.5 |
| n [symbol] (×10 [symbol] ) | 1.26 | 1.00 | 6.25 |
| τ₀ (keV) | 30.0 | 18.0 | 11.0 |

[symbol]

indicates data missing or illegible when filed

The thickness of the plots in FIGS. 14A to 14D represent the variation in the alpha particle confinement time (R). From these plots it will be noted that, after approximately 40 seconds, all three devices reach a steady-state operation where the rate of the ash production is equal to the rate of the ash loss. Table 3 summarises this steady-state operations for the three devices and shows the percentage decrease in

TABLE 3
Comparison of DT dilution in different devices and the resulting decrease in
fusion power, for different alpha particle confinement times (τₐₗₚₕₐ = Rτ_{E}).

| | ITER | STPP | Compact ST reactor |
|---|---|---|---|
| P_{fus} no ash (GW) | 0.87 | 4.12 | 0.24 |
| P_{fus} steady-state (GW) | 0.77 | 3.31 | 0.23 |
| Decrease in P_{fus} (%) | 12 | 20 | 5 |
| Dilution | 0.89 | 0.81 | 0.95 |

| | ITER | | | STPP | | | Compact ST reactor | | |
|---|---|---|---|---|---|---|---|---|---|
| P_{fus} no ash (GW) | 0.87 | | | 4.12 | | | 0.24 | | |
| Alpha confinement | R = 3 | R = 4 | R = 5 | R = 3 | R = 4 | R = 5 | R = 3 | R = 4 | R = 5 |
| P_{fus} steady-state (GW) | 0.80 | 0.77 | 0.75 | 3.47 | 3.31 | 3.16 | 0.23 | 0.23 | 0.23 |
| Decrease in P_{fus} (%) | 9 | 12 | 14 | 16 | 20 | 23 | 4 | 5 | 6 |
| Dilution | 0.91 | 0.89 | 0.86 | 0.85 | 0.81 | 0.78 | 0.96 | 0.95 | 0.94 |

It can be seen that dilution plays a significant role in the large, high-power STPP reactor (fusion output decreased by ˜20%; with R=4); a moderate role in ITER (˜12% decrease); and a negligible role (˜5% decrease) in the compact high field ST reactor.

The calculated low dilution in the compact ST reactor is connected with a relatively low confinement in such a small device. However the efficiency (H-factor, beta, Q_{fus}) can still be good enough to make a compact ST reactor attractive. The problem of the ash accumulation is a serious issue for ITER, DEMO and Fusion Power Plants.

Thus full-orbit simulations of the alpha particle containment in a compact ST reactor show a possibility of a reduction in the plasma current necessary for alpha containment. This reduction is very important as it could reduce the auxiliary power required for the current drive in a solenoid-less ST reactor, which may significantly enhance the economics of the energy production. While the deposition profile calculations can possibly be done with the guiding center model, the full gyro-orbit model is necessary for the alpha wall deposition. The wall load from alphas is not negligible, but is tolerable in a compact ST reactor. DT dilution due to the ash seems to play a negligible role in compact reactors, but to be important in a larger ST power plant.

Main Parameters of ECFR The ECFR device is a long-pulse spherical tokamak with an elongated plasma, and a double-null divertor. The design objectives are to demonstrate routine steady-state operation in hydrogen (enabling optimisation and any necessary modifications to be made without problems of radioactivity), before proceeding to deuterium-deuterium (DD) and then, if desired, to a deuterium-tritium (DT) mix where considerable neutron fluence would result. The design incorporates optional features (notably shielding/neutron reflectors and a heavy water blanket) which allow control of the neutron output for test purposes.

Standard operation produces significant D-T fusion power for a burn length of longer than 1000 sec which is determined as a “quasi steady-state” for most engineering requirements. The injection of neutral beams of energy up to about 200 keV provides the main source of auxiliary power and can assist current drive. RF heating and current drive is also considered.

Start-Up and Ramp-Up

In existing tokamaks the plasma current is initiated by transformer action using a large central solenoid. It is planned to obtain start-up and ramp-up of the plasma current in ECFR without use of a large central solenoid because, in the final design, the large neutron fluence may prohibit its use, as there may be insufficient space for the extensive shielding required to protect the windings. In the present invention a wider range of techniques may be used.

A major advantage of the spherical tokamak is that the plasmas (having low aspect ratio and high elongation) have low inductance, and hence large plasma currents are readily obtained—the input of flux from the increasing vertical field necessary to restrain the plasma is also significant at low aspect ratio [17].

Experiments on MAST have demonstrated start-up using a 28 GHz 100 kW gyrotron (assisted by vertical field ramp) at an efficiency of 0.7 A/Watt [18]. A gyrotron fitted to ECFR could have power ˜1 MW and is predicted to produce a start-up current of ˜700 kA.

An alternative scheme is to use a small solenoid (or pair of upper/lower solenoids) made using mineral insulation with a small shielding (or designed to be retracted before D-T operation begins); it is expected that such a coil would have approximately 25% of the volt-secs output as an equivalent solenoid as used on MAST or NSTX. Initial currents of order 0.5 MA are expected. The combination of both schemes would be especially efficient.

A novel development of the ‘retractable solenoid’ concept is to use a solenoid wound from HTS, to cool it in a cylinder of liquid nitrogen outside the tokamak, insert it into the centre tube whilst still superconducting, pass the current to produce the initial plasma, then retract the solenoid before D-T operation. Advantages of using HTS include lower power supply requirements, and the high stresses that can be tolerated by the supported HTS winding.

This initial plasma current will be an adequate target for the lower energy NBI beams, and the heating and current drive they produce will provide current ramp up to the working level.

Heating and Current Drive

As previously discussed, it is desirable to obtain a significant fluence of neutrons at minimum auxiliary heating and minimum current drive, in order to minimise build costs, running costs, and to keep divertor heat loads at tolerable levels.

Recent energy confinement scalings, derived from recent results on both MAST at CCFE and NSTX at Princeton suggest that energy confinement in an ST has a stronger dependence on magnetic field, and a lower dependence on plasma current, than for conventional tokamaks, and hence is improved for the high field of this design.

Various methods of heating (and current drive) including NBI and a range of radio-frequency (RF) methods may be appropriate. NBI is the most widely used scheme and has the advantages of easy injection into the plasma, and less sensitivity to plasma parameters than most RF methods.

NBI is also the most commonly used method of current drive. Its efficiency depends on many parameters—beam energy, angle of injection, density of plasma. Typically 1 MW of NBI may drive 0.1 MA of plasma current; and since NBI costs approx £3M per MW, this is a major cost. A potentially helpful feature is the self-driven ‘bootstrap’ current, produced in a hot, high energy, plasma, which can account for one-half or more of the required current. However bootstrap current increases with density, whereas NBI current drive reduces at high density, so a careful optimisation is required.

Thermal Load on Divertors

Some of the energy pumped into a plasma either to heat it or produce current drive emerges along the scrape-off-layer (SOL) at the edge of the plasma, which is directed by divertor coils to localised divertor strike points. The power per unit area here is of critical concern in all fusion devices, and would not normally be acceptable in a small neutron or energy source. However in the present proposal the input power is greatly reduced (of order of a few MW, compared to tens of MW in other designs) so the divertor load is correspondingly reduced. Additional methods are used to reduce the load per unit area further, by a combination of strike-point sweeping; use of the ‘natural divertor’ feature observed on START; and use of divertor coils to direct the exhaust plume (as advocated by Peng & Hicks [19]); possibly to expand the footprint to large radius as in the ‘super—X’ divertor advocated by Kotschenreuther et al [11]. This latter normally requires large currents in the divertor control coils, as these have to be somewhat removed from the neutron source for protection: however this demand is made tractable here because of the modest plasma current required. Further benefit may be gained by use of a flow of liquid lithium over the target area which will also be used to pump gases from the vessel, for example in a closed lithium flow loop.

General Outline of this Device A cross section of a spherical tokamak with conventional copper magnets suitable for use as a neutron source is shown in FIG. 2. The major components of the tokamak are a toroidal field magnet (TF) 41, optional small central solenoid (CS) 42 and poloidal field (PF) coils 43 that magnetically confine, shape and control the plasma inside a toroidal vacuum vessel 44. The centring force acting on the D-shaped TF coils 41 is reacted by these coils by wedging in the vault formed by their straight sections. The outer parts of the TF coils 41 and external PF coils are optionally protected from neutron flux by a blanket (which may be D₂O) and shielding 45. The central part of TF coils, central solenoid and divertor coils are only protected by shielding.

The vacuum vessel 44 may be double-walled, comprising a honey-comb structure with plasma facing tiles, and directly supported via the lower ports and other structures. Integrated with the vessel are optional neutron reflectors 46 that could provide

confinement of fast neutrons which would provide up to 10-fold multiplication of the neutron flux through ports to the outer blanket where neutrons either can be used for irradiation of targets or other fast neutral applications, or thermalised to low energy to provide a powerful source of slow neutrons. The reason for such assembly is to avoid interaction and capture of slow neutrons in the structures of the tokamak. The outer vessel optionally contains D₂O with an option for future replacement by other types of blanket (Pb, salts, etc.) or inclusion of other elements for different tests and studies. The outer shielding will protect the TF and PF coils, and all other outer structures, from the neutron irradiation. The magnet system (TF, PF) is supported by gravity supports, one beneath each TF coil. Ports are provided for neutral beam injection 47 and for access 48.

Inside the outer vessel the internal components (and their cooling systems) also absorb radiated heat and neutrons from the plasma and partially protect the outer structures and magnet coils from excessive neutron radiation in addition to D₂O. The heat deposited in the internal components in the vessel is ejected to the environment by means of a cooling water system. Special arrangements are employed to bake and consequently clean the plasma-facing surfaces inside the vessel by releasing trapped impurities and fuel gas.

The tokamak fuelling system is designed to inject the fuelling gas or solid pellets of hydrogen, deuterium, and tritium, as well as impurities in gaseous or solid form. During plasma start-up, low-density gaseous fuel is introduced into the vacuum vessel chamber by the gas injection system. The plasma progresses from electron-cyclotron-heating and EBW assisted initiation, possibly in conjunction with flux from small retractable solenoid(s), and/or a ‘merging-compression’ scheme (as used on START and MAST), to an elongated divertor configuration as the plasma current is ramped up. A major advantage of the ST concept is that the plasmas have low inductance, and hence large plasma currents are readily obtained if required—input of flux from the increasing vertical field necessary to restrain the plasma being significant [18]. Addition of a sequence of plasma rings generated by a simple internal large-radius conductor may also be employed to ramp up the current.

After the current flat top is reached, subsequent plasma fuelling (gas or pellets) together with additional heating leads to a D-T burn with a fusion power in the MW range. With non-inductive current drive from the heating systems, the burn duration is envisaged to be extended well above 1000 s and the system is designed for steady-state operations. The integrated plasma control is provided by the PF system, and the pumping, fuelling (H, D, T, and, if required, He and impurities such as N_{2,} Ne and Ar), and heating systems based on feedback from diagnostic sensors.

The pulse can be terminated by reducing the power of the auxiliary heating and current drive systems, followed by current ramp-down and plasma termination. The heating and current drive systems and the cooling systems are designed for long pulse operation, but the pulse duration may be determined by the development of hot spots on the plasma facing components and the rise of impurities in the plasma.

The approach outlined above enables the design of an Efficient Compact Fusion Reactor (ECFR) that is much smaller than previous designs of fusion reactors aimed at generating net power, having correspondingly lower construction and operational costs (volume from ⅕ to 1/15 of existing designs, magnetic field energy and tritium consumption 10-100 times lower). The ECFR is an ideal first device to evaluate previously untested areas such as steady-state operation, plasma control, tritium operation, etc whilst producing at least 1 MW of fusion neutrons ideal for scientific research, materials tests, production of isotopes for medical and other applications, etc. ECFR is capable of producing net energy over an extended length of time. As such it can be much more than a useful demonstration of fusion technology, it can be the first viable demonstration of a fusion power station.

This design is made possible by a novel combination of new and established techniques over a wide range covering plasma initiation; ramp-up of plasma current; key methods of enhancing neutron production at relatively low current, field and auxiliary heating; use of improved energy confinement; means of varying the neutron energy in a controllable and tunable manner; efficient means of producing steady-state operation; methods of handling the exhaust heat load; special methods of construction, featuring shielding and optional reflectors to both protect coil windings and control the neutron output; and the use of HTS to enable exceptionally high toroidal fields in a small spherical tokamak.

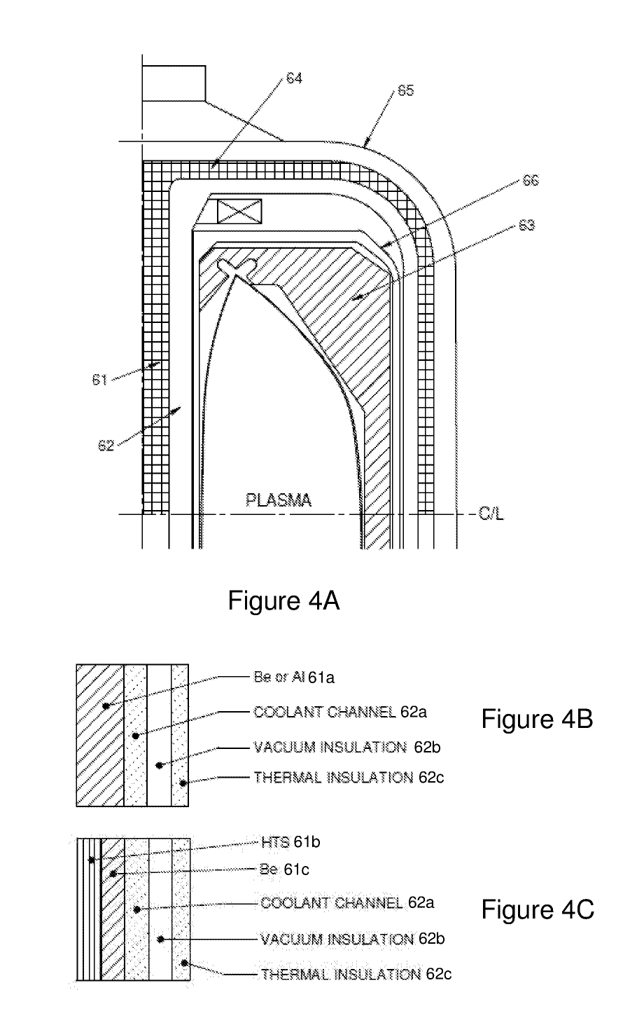

A quarter cross section of a spherical tokamak with HTS magnets suitable for use as an energy or neutron source is shown in FIG. 4A. The important features of this tokamak in addition to the major components shown in FIG. 2 are a centrepost 61 that can be either HTS or beryllium or aluminium, thermal insulation and cooling channels 62 to allow the centrepost to be cooled, shielding 63 to prevent neutron damage to the outboard coil 64 made from HTS, a cryostat 65 to cool the HTS and a vacuum vessel 66 which can be inside or outside the shielding 63.

There are several options for the centrepost 61. One option includes HTS with or without neutron shielding. Another option is shown in FIG. 4B and includes an inner part 61a of beryllium, aluminium or another non-HTS material, a coolant channel 62a, vacuum insulation 62b and thermal insulation 62c. A further option is shown in FIG. 40 and is formed by a combination in which an inner part 61b is made of HTS and an outer part 61c is made of beryllium, aluminium or another non-HTS material that provides some shielding against damage to the HTS from neutrons. Additional neutron shielding can be added to each option, subject to the space constraints in a spherical tokamak.

Plasma initiation: methods include merging-compression; magnetic pumping whereby an oscillating current produces plasma rings which augment the plasma current; use of a retractable solenoid, or pair of such solenoids; RF current initiation by a gyrotron.

Current ramp-up: methods include retractable solenoid(s), which may be pre-cooled high temperature superconductor solenoids; RF current drive; and the efficient drive produced by heating the plasma so that the rapid increase in poloidal field necessary to contain the growing plasma inputs almost sufficient flux to ramp up the plasma current to the desired working value.

Enhanced neutron production: in a conventional fusion device nearly all neutron production arises from thermal fusion in the central highest temperature region of the plasma. In contrast, in the SCFNS super-compact neutron source, most neutron production is from interaction of one or more neutral beams with the plasma. In the proposed ECFR device, the high value of the toroidal field provides high plasma temperatures, and neutron output is a mix of thermal and beam-thermal fusion. New modeling shows that neutron production is further enhanced by te relatively long path of the NBI beam when directed at optimum angle through the highly-elongated plasma (a natural feature of an ST) and by optimising the tritium fraction. The tritium fraction may be optimised by the use of either deuterium or tritium neutral beams which will provide refuelling as well as heating and current drive.

Variable neutron energy: in a conventional fusion device the neutron energy is fixed at 14 MeV for D-T fusion and 2.5 MeV for D-D fusion. In one version of the proposed device an antenna configured to induce ion cyclotron resonance heating (ICRH) would be mounted inside the toroidal chamber. This ICRH system could also be configured to increase the energy of the emitted neutrons by several MeV in a controllable and tunable manner.

Favourable confinement scaling: recent research suggests that energy confinement in an ST has a stronger dependence on magnetic field, and a lower dependence on plasma current, than the ITER scalings derived for conventional tokamaks. This prediction is very promising for the high field, and relatively low plasma current, of ECFR.

Construction features: insulation of the low-voltage toroidal field coil segments can be by stainless steel which combines great strength and relatively high resistance; the TF system may be demountable, utilising high-duty versions of the feltmetal sliding joints developed by Voss at CCFE; the device itself could feature a combination of heavy-water tanks and layers of shielding/reflectors (eg of Be or Pb) to protect the PF coils and external TF coils from lower energy neutrons, and to direct the main stream of neutrons for research and processing tasks.

It is also possible to shoot positive ion beams directly into the plasma through iron tubes which shield out the magnetic field.

It will be appreciated that compact fusion reactors such as those described herein have a much larger surface area per unit plasma volume than bigger tokamaks. In general costs and implementation difficulty scale at least linearly with plasma volume, while energy output (which can be considered to be limited by acceptable damage levels) scales linearly with surface area. In addition, the costs of a “one (or few) of a kind” device are well known to be higher than the costs of “many of a kind” devices. It therefore seems likely that many smaller fusion reactors should be cheaper per unit net power output than one large fusion reactor.

It has thus become apparent that compact, low aspect ratio, tokamaks do not have to be large to achieve high fusion power gain; in fact they can even achieve high gain at low total power. To achieve such gain a significant proportion of tritium in the plasma is helpful: preferably at least 25% (i.e. a ratio of 25:75 tritium ions:deuterium ions) but higher proportions of 30%, 40% or even 50% or more could lead to much higher power. Previously it has been believed impossible to confine the a-particles generated from such high proportions of tritium in a small tokamak. However, the inventors have now appreciated that a plasma current as low as 1 MA may be sufficient to confine most of the alphas in a moderate field low aspect ratio tokamak (to allow self-heating of the plasma); and the performance of a compact fusion power plant may be much greater than expected due to two reasons. Firstly a recent re-evaluation of energy confinement scalings shows that high-beta devices such as the spherical tokamak provide a greater energy gain than suggested by the conventional ITER scaling. Secondly, even more significantly, turbulence may be suppressed in the combination of moderately high field and low aspect ratio of a spherical tokamak power plant. This invention could form a major breakthrough in the search for economic fusion power, as anomalous turbulence is the major driver towards large volume; and these new developments together make the ideal of a compact, high gain fusion power module more realizable. Although alpha confinement in a small spherical tokamak is worse than in a conventional tokamak at high plasma current, it is better at low plasma current. The combination of features which achieves this is high field, small size, low aspect ratio and low plasma current and this ability to operate at low plasma current, while containing sufficient alphas, makes high Q possible, and this has previously not been thought to be feasible.

It will be appreciated that variations from the above described embodiments may still fall within the scope of the invention.

### REFERENCES

[1] Jassby D L ‘Optimisation of Fusion Power Density in the Two Energy Component Tokamak Reactor’ Nuclear Fusion 1975 Vol 15 p 453

[2] A. Sykes et al, ‘Fusion for Neutrons—a realizable fusion neutron source’, Proc of 24^{th} IEEE Symposium on Fusion Enginering, Chicago 2011 Invited Paper SO2B-1

[3] M. Valovic et al, Nuclear Fusion 51(2011) 073045

[4] C Hellesen et al, Nuclear Fusion 50 (2010) 022001

[5] R D Stambaugh et al, ‘The Spherical Tokamak Path to Fusion Power’, Fusion Technology Vol 33 P 1(1998)

[6] T C Hender et al, ‘Spherical Tokamak Volume Neutron Source’, Fusion Engineering and Design 45 (1990) p 265

[7] H R Wilson et al The Physics Basis of a Spherical Tokamak Component Test Facility Proc. 31^{st} EPS Conf 2004

[8] G M Voss et al, ‘Conceptual design of a Component Test Facility based on the Spherical Tokamak’, FED 83 (2008) p 1648

[9] A Dnestrovskij et al, Plasma Devices and Operations, 15, 2007, p 1

[10] Y-K M Peng et al 2005 Plasma Phys. Control. Fusion 47 B263

[11] M. Kotschenreuther, P. Valanju, S. Mahajan, L. J. Zheng, L. D. Pearlstein, R. H. Bulmer, J. Canik and R. Maingi ‘The super X divertor (SXD) and a compact fusion neutron source (CFNS)’ Nucl. Fusion 50 (2010) 035003 (8 pp)

[12] R M 0 Galvao et al, ‘Physics and Engineering Basis of a Multi-functional Compact Tokamak Reactor Concept’, in Fusion Energy 2008, (Proc. 22nd Int. Conference Geneva, 2008) (Vienna: IAEA) CD-ROM file [FT/P3-20] and http://mvw-naweb.iaea.orginapciphysics/FEC/FEC2008/htmliindex.htm

[13] B V Kuteev et al, ‘Plasma and Current Drive parameter options for a low-power Fusion Neutron Source’ 23rd IEEE/NPSS Symposium on Fusion Engineering, 2009. SOFE 2009.

[14] D L Jassby, Comments Plasma Phys. Controlled Fusion, 3 (1978) 151

[15] Y-K. M. Peng and D. J. Strickler, Nucl. Fusion 26, 769 (1986).

[16] M Gryaznevich et al, Phys. Rev. Letters, 80, (1998) 3972

[17] O. Mitarai and Y. Takase, Plasma current ramp-up by the outer vertical field coils in a spherical tokamak reactor, Fusion Sci. Technol. 43 (2003),

[18] V. Shevchenko, Nuclear Fusion Vol 50 (2010) p 22004

[19] Y-K M Peng and J B Hicks: proceedings of the 16th Symposium on Fusion Technology, London U.K., 3-7 September 1990, Vol 2 p 1288

[20] V. Selvamanickam, “2G HTS Wire for High Magnetic Field Applications,” HTS4Fusion Conductor Workshop, May 26-27, 2011, Karlsruhe, Germany.

[21] M Gryaznevich, A Sykes, A E Costley, J Hugill, G Smith and D Kingham. Proc. 40th EPS Conference, Helsinki, 1-5 Jul. 2013, Europhysics Conferences Abstracts, Vol. 37F (2013) P 2.111

[22] A Nikolai and M Gryaznevich, Plasma Phys. Control. Fusion 54 (2012) 085006

[23] R. H. Fowler, J. A. Holmes, J. A. Rome “NFREYA—A Monte Carlo Beam Deposition Code for Noncircular Tokamak Plasmas” Report ORNL/JTM-6845 (1979)

[24] G. G. Lister, D. E. Post, R. Goldston, Computer Simulations of Neutral Injection into Tokamaks Using Monte Carlo Techniques, 303, Third Symposium of Plasma Heating in Toroidal Devices, Varenna, Italy, 1976

[25] R. L. Freeman, and E. M. Jones, Analytic expressions for selected cross-sections and Maxwellian rate coefficients, CLM—R 137, Culham Laboratory, Abingdon, U. K., 1974

[26] F. H. Holt, R. E. Haskell, Foundations of Plasma Dynamics, The MacMillan Company, New York (1965).

[27] M. N. Rosenbluth, W. M. MacDonald, D. L. Judd, Phys. Rev. 107 (1957) 1

[28] J. G. Cordey, M. J. Houghton, Nucl. Fus. 13 (1973) 215

[29] R. H. Fowler, J. D. Callen, J. A. Rome, J. Smith, “FIFPC, A Fast Ion Fokker-Planck Code” Report ORNLJTM-5487

[30] H. L. Stone, SIAM J. Numer. Anal. 5, (1968) 530

[31] B. V. Kuteev, et al. Nucl. Fusion 51 (2011) 073013

[32] L M Hively, G. H. Miley, Nuclear Fusion 17 (1977) 5

[33] V I Afanasyev, et al., Plasma Phys. Control. Fusion, 55 (2013)

1. A compact nuclear fusion reactor comprising a toroidal plasma chamber in which is confined a plasma comprising tritium and deuterium ions, and a plasma confinement system arranged to generate a magnetic field for confining the plasma in the plasma chamber, wherein:
the plasma confinement system is configured so that the major radius of the confined plasma is 1.5 m or less, preferably 1.2 m or less, preferably 1.0 m or less preferably 0.8 m or less, more preferably 0.6 m or less;
the magnetic field in use includes a toroidal component of 5 T or less, preferably 4 T or less, preferably 3 T or less, more preferably 2 T or less;
the plasma current is 5 MA or less, preferably 4 MA or less, preferably 3 MA or less, more preferably 2 MA or less, more preferably 1 MA or less;
the aspect ratio is 2.5 or less, preferably less than 2.2, more preferably less than 2.0, more preferably less than 1.8, more preferably less than 1.7; and
a fraction of a-particles generated in the reactor which are confined within the plasma is 0.4 or greater, preferably 0.5 or greater, more preferably 0.6 or greater, more preferably 0.7 or greater, more preferably 0.8, more preferably 0.9 or greater.

2. The fusion reactor of claim 1, wherein a ratio of tritium ions to deuterium ions in the plasma is at least about 25:75, preferably at least about 40:60, more preferably at least about 50:50.

3. The fusion reactor of claim 1, wherein the plasma confinement system includes toroidal field magnets made from material comprising high temperature superconductor, preferably cooled in use to 80K, more preferably to 30K or less, more preferably to 4K or less.

4. The fusion reactor of claim 1, further including one or more of the following features:
neutral beams are directed into the plasma from different directions selected to optimise fusion reactions between particles in the beams;
the reactor is configured so that power input to the plasma is less than 100 MW, preferably less than 10 MW, more preferably less than 6 MW, more preferably less than 3 MW, more preferably less than 1 MW, more preferably less than 500 kW;
the reactor is arranged to operate at a fusion energy gain factor Q_{eng}>1, more preferably Q_{eng}>3, more preferably Q_{eng}>10, more preferably Q_{eng}>15, more preferably Q_{eng}>20, and operated either as an efficient neutron source or an energy source;
the plasma is maintainable in a steady state for more than 10 seconds, preferably more than 100 seconds, more preferably more than 1000 seconds, more preferably more than 10000 seconds; and
the plasma current is driven without induction.

5. The fusion reactor of claim 4, arranged to initiate the plasma using one or more of the following operations:
merging-compression;
magnetic pumping so that an oscillating current produces plasma rings to augment the plasma current;
activation of one or more solenoids, optionally retractable solenoids, located in a central core of the toroidal chamber; and
RF current initiation by a gyrotron or other RF source;
and optionally arranged to ramp up the plasma current using one or more of the following operations:
activation of the one or more solenoids;
RF current drive; and
heating the plasma so that a rapid increase in poloidal field necessary to contain the plasma as it grows inputs almost sufficient flux to ramp up the plasma current to a desired working value.

6. The fusion reactor of claim 1 in which the material from which the toroidal field magnets are constructed is configured to provide an increased current density, optionally by including non-HTS layers having a combined thickness of less than about 90 microns or HTS layers having a thickness greater than about 1 micron within the HTS manufactured material, in order to allow more space for neutron shielding.

7. The fusion reactor of claim 1, wherein the plasma confinement system is configured so that □-particles generated in the plasma are confined.

8. The fusion reactor of claim 1, wherein beta, the ratio of plasma pressure to magnetic pressure, is greater than 5%, preferably greater than 10%, more preferably greater than 20%, more preferably greater than 30%.

9. The fusion reactor of claim 1, wherein the plasma energy confinement time is at least 10% greater than conventionally predicted, preferably 50% greater, more preferably 100% greater, more preferably 2 times greater, more preferably 5 times greater, more preferably 10 times greater.

10. The fusion reactor of claim 1, further comprising divertors optimised to reduce the load per unit area on the walls of the plasma chamber, wherein part of all of the surface of the divertors is optionally coated with lithium.

11. The fusion reactor of claim 1, wherein part or all of the surface of the plasma facing wall is coated with lithium.

12. A power station comprising a plurality of fusion reactors as claimed in claim 1.

13. A method of generating neutrons or energy by operating a nuclear fusion reactor comprising a toroidal plasma chamber, the method comprising:
initiating a plasma in the plasma chamber, the plasma comprising tritium and deuterium ions;
generating a magnetic field with a toroidal component of 5 T or less, preferably 4 T or less, preferably 3 T or less, more preferably 2 T or less;
confining the plasma with a major radius of 1.5 m or less, preferably 1.2 m or less, preferably 1.0 m or less preferably 0.8 m or less, more preferably 0.6 m or less and an aspect ratio of 2.5 or less, preferably less than 2.2, more preferably less than 2.0, more preferably less than 1.8, more preferably less than 1.7;
operating a plasma current of 5 MA or less, preferably 4 MA or less, preferably 3 MA or less, more preferably 2 MA or less, more preferably 1 MA or less;
emitting neutrons and other energetic particles; and
confining in the plasma a proportion of α-particles generated in the reactor said proportion being 0.4 or greater, preferably 0.5 or greater, more preferably 0.6 or greater, more preferably 0.7 or greater, more preferably 0.8, more preferably 0.9 or greater.

14. The method of claim 13, wherein a ratio of tritium ions to deuterium ions in the plasma is at least about 25:75, preferably at least about 40:60, more preferably at least about 50:50.

15. The method of claim 13, wherein the plasma operates at a fusion energy gain factor Q_{eng}>1, more preferably Q_{eng}>3, more preferably Q_{eng}>10, more preferably Q_{eng}>15, more preferably Q_{eng}>20.

16. The method of claim 13, further comprising maintaining the plasma in a steady state for at least 10 seconds, preferably at least 100 seconds, more preferably at least 1000 seconds, more preferably at least 10000 seconds.

17. The method of claim 13, wherein the neutrons are generated at a rate of at least 3×10¹⁷ neutrons per second, preferably at least 10¹⁸ neutrons per second, more preferably at least 10¹⁹ neutrons per second, more preferably at least 10²⁰ neutrons per second.
